(19) United States
(12) Patent Application Publication
(10) Pub. No.: US 2020/0323283 A1
(43) Pub. Date: Oct. 15, 2020

(54) A Method And A System For Detection Of Characteristics Of A Fastener Of An Item Of Apparel

(71) Applicant: THE NORTH FACE APPAREL CORP.

(72) Inventors: Benjamin Cooper, Dover, NH (US); Tadd Nicholas Smith, Rye, NH (US)

(21) Appl. No.: 16/306,427

(22) PCT Filed: Jun. 1, 2017
(86) PCT No.: PCT/US2017/035355

§ 371 Date: Nov. 30, 2018

Related U.S. Application Data
(60) Provisional application No. 62/344,684, filed on Jun. 2, 2016.

(51) Int. Cl. A41D 1/00; A44B 19/26; A44B 99/00; H04L 29/08

(52) U.S. Cl. CPC A41D 1/002; H04L 67/12; A44B 99/00; A44B 19/26

(57) ABSTRACT

System and methods for managing apparel are disclosed. One method includes receiving information indicative of an magnetically energized sensor disposed adjacent a fastener associated with an item of apparel; determining a characteristic of the fastener based at least upon the received information; and providing a response to a wearer of the item of apparel based at least upon the characteristic of the fastener.

### TECHNICAL FIELD

This patent disclosure relates generally to sensing technology for apparel and more particularly to methods and systems for sensing and controlling various characteristics relating to fasteners for apparel.

### BACKGROUND

Various fasteners may be used to couple portions of apparel together and/or to enclose certain areas, such as a jacket around a wearer's body and a fabric bag enclosing a storage space. For example, a zipper type fastener may be used to couple two panels of a short or jacket together in order to provide coverage over a wearer. As another example, a satchel may include a storage space that may be enclosed by actuating a zipper fastener to linearly couple two sides of the satchel. However, the actuation of the conventional fasteners are manually implemented by a user and information relating to the fastener position and actuation may be limited to the user. Therefore, improvements in fasteners and associated apparel are needed.

### SUMMARY

This patent disclosure relates to system and methods for sensing various characteristics relating to apparel and wearers of the same. Such characteristics may include characteristics of a fastener such as a zipper type fastener.

In an aspect, a method may include receiving information indicative of an magnetically energized sensor disposed adjacent a fastener associated with an item of apparel; determining a characteristic of the fastener based at least upon the received information; and providing a response to a wearer of the item of apparel based at least upon the characteristic of the fastener.

In another aspect, a system may include a moveable fastener configured to cause two opposing portions of an item of apparel to be selective coupled and uncoupled based on movement of the fastener; a sensor disposed adjacent a portion of the fastener, wherein a movement of the fastener relative to the sensor causing an electrical current to be generated in the sensor; and causing transmission of information relating to the generated electrical current.

In a further aspect, a system may include a moveable fastener configured to cause two opposing portions of an item of apparel to be selective coupled and uncoupled based on movement of the fastener; an electrical actuator disposed adjacent a portion of the fastener, wherein an energizing of the actuator cause movement or limits movement of the fastener relative to the actuator; and receiving an electrical signal at the actuator to energize the actuator.

### BRIEF DESCRIPTION OF THE DRAWINGS

FIG. 1 is a block diagram of an example system and network in accordance with aspects of the disclosure.

FIG. 2 is a block diagram of an example system and network in accordance with aspects of the disclosure.

FIG. 3 is a block diagram of an example system and network in accordance with aspects of the disclosure.

FIG. 4 is a flow chart of an example method in accordance with aspects of the disclosure.

FIG. 5 is a block diagram of a computer system configured to implement the method of FIG. 4.

### DETAILED DESCRIPTION

In accordance with aspects of the disclosure, systems and methods provide a tool for determining characteristics of a wearer of apparel. As an example, one or more items of clothing may include a sensor configured to measure a characteristic relating to a fastener associated with the items of clothing. Such characteristic information may be transmitted to a computing device for additional processing. In certain aspects, the sensor may communicate measured information to a user device such as a mobile device. As such, the user device may be configured to process the measured data and/or to transmit the measured data over a network or communication path for processing. However, various configurations of sensors, computing devices, and communication mechanisms may be used, as described in further detail below.

The term “apparel” may be defined as one or more articles of clothing and may include outerwear, underwear, upper body wear, lower body wear, hats, gloves, footwear, and the like. The term “apparel” may be defined to include back packs, bags, purses, luggage, and the like. The term “clothing” may be used to reference apparel and is not limiting to particular garments, headgear, gloves, footwear, or the like.

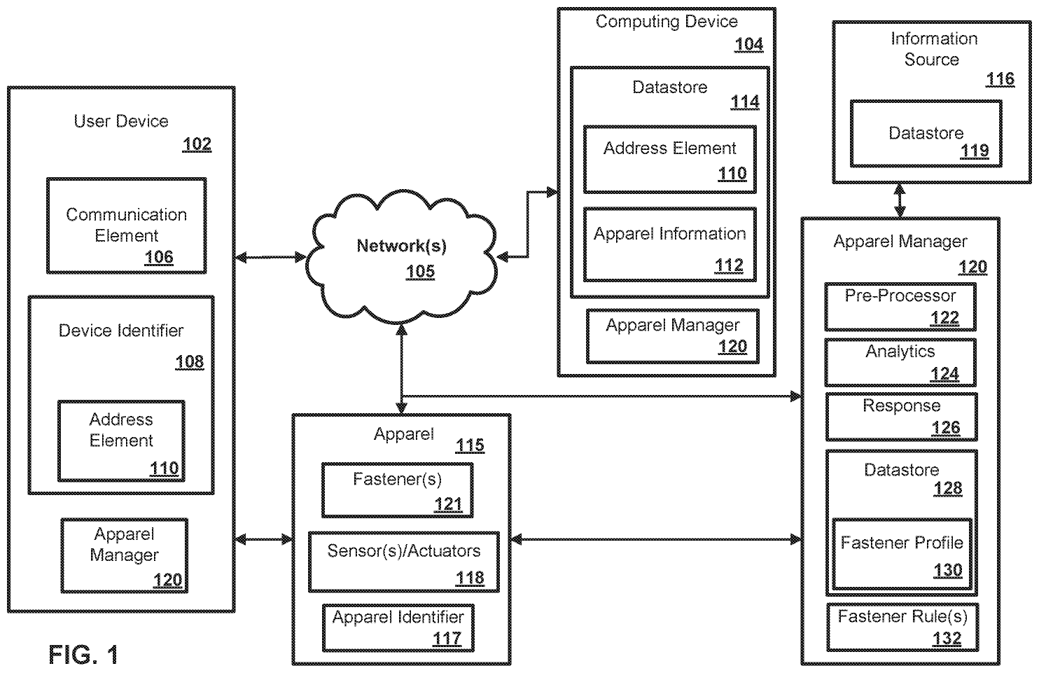

FIG. 1 illustrates various aspects of an exemplary network in which the present methods and systems may operate. Those skilled in the art will appreciate that present methods may be used in various types of networks and systems that employ both digital and analog equipment. The system is described as comprised of elements. An element may be software, hardware, or a combination of software and hardware. One skilled in the art will appreciate that provided herein is a functional description and that the respective functions may be performed by software, hardware, or a combination of software and hardware.

The system and network may include a user device 102 (e.g., physical computer host, virtual machine, IP-capable device) in communication with a computing device 104 such as a server or Network Interface Device (NID), for example. The computing device 104 may be disposed locally, or remotely, relative to the user device 102. As an example, the user device 102 and the computing device 104 may be in communication via a private and/or public network 105 such as the Internet. Other forms of communications may be used such as wired and wireless telecommunication channels, for example.

In an aspect, the user device 102 may be an electronic device such as a computer, a mobile device, a smartphone, a laptop, a tablet, a display device, or other device capable of communicating with the computing device 104. The user device 102 may be configured to communicate information relating to one or more items of clothing (apparel) and/or wearers of the same. The user device 102 may be configured to determine and communicate information relating to another device such as a sensor 118 disposed in or adjacent the apparel.

For example, the user device 102 may be or comprise a mobile computing device such as a smart phone, handheld device, or tablet. The user device 102 may be operatively coupled to one or more networks such as an IP network, a cellular network, near-field network, Bluetooth, ZigBee, or other network specification or protocol. The user device 102 may communicate with the sensor 118 to send and receive signals. In certain aspects, the user device 102 is configured to receive information from the sensor relating to one or more measured characteristics such as characteristics relating to one or more fasteners 121. Such characteristics may include absolute position, relative position, movement, and the like. The user device 102 may be configured to communicate with other devices such as the computing device 104. The user device 102 may receive information from the sensor 118 and may transmit the information to the computing device 104.

The user device 102 may include a communication element 106 for providing an interface to a user to interact with the user device 102 and/or the computing device 104. The communication element 106 may be any interface for presenting information to the user and receiving user feedback, such as a web browser (e.g., Internet Explorer, Mozilla Firefox, Google Chrome, Safari, or the like) or proprietary software, for example. Other software, hardware, and/or interfaces may be used to provide communication between the user and one or more of the user device 102 and the computing device 104. As an example, the communication element 106 may request or query various files from a local source and/or a remote source. As a further example, the communication element 106 may transmit data to a local or remote device such as the computing device 104.

In an aspect, the user device 102 may be associated with a user identifier or device identifier 108. As an example, the device identifier 108 may be any identifier, token, character, string, or the like, for differentiating one user or user device (e.g., user device 102) from another user or user device. In a further aspect, the device identifier 108 may identify a user or user device as belonging to a particular class of users or user devices. As a further example, the device identifier 108 may include information relating to the user device, such as a manufacturer, a model or type of device, a service provider associated with the user device 102, a state of the user device 102, a locator, and/or a label or classifier. Other information may be represented by the device identifier 108. The device identifier 108 may be used for authentication of a user/user device to manage access to particular services or information.

In an aspect, the device identifier 108 may include an address element 110 such as an internet protocol address, a network address, an Internet address, or the like. As an example, the address element 110 may be relied upon to establish a communication session between the user device 102 and the computing device 104 or other devices and/or networks. As a further example, the address element 110 may be used as an identifier or locator of the user device 102.

In an aspect, the computing device 104 may be a server for communicating with the user device 102, other computing devices 104, and/or physical or logical components including, for example, sensors (e.g., sensor 118). As an example, the computing device 104 may communicate with the user device 102 for providing services such as peer-to-peer communication and comfort management services. In an aspect, the computing device 104 may allow the user device 102 to interact with remote resources, such as data, devices, files, and computing elements associated with one or more users or items of apparel 115. As an example, the computing device may be configured as computing module for a particular item of apparel 115. As such, the user device 102 may interact with the computing device 104 to control functions relating to the apparel 115.

In an aspect, the computing device 104 may manage the communication between the user device 102 and a datastore 114 for sending and receiving data therebetween. As an example, the datastore 114 may store a plurality of files, webpages, user identifiers or records, or other information. As a further example, the user device 102 may request and/or retrieve a file from the datastore 114. In an aspect, the datastore 114 may store information relating to the user device 102, such as the address element 110 and/or apparel information 112. Apparel information 112 may include identifiers of certain items of clothing (e.g., smart apparel), the number and/or types of sensing technology associated with the apparel, measured information from the sensor 118 or other information source, user data such as a location, habits, preferences, and the like. Any information may be stored in and retrieved from the datastore 114. The datastore 114 may be disposed remotely from the computing device 104 and accessed via direct or indirect connection. The datastore 114 may be integrated with the computing device 104 or some other device or system.

As described herein, various items of apparel 115 may be configured to receive or access information such as to operate as a “smart” sensing technology. As an example, the apparel 115 may include one or more of the sensors 118 for continuously or periodically measuring characteristics of the apparel 115, wearer, and/or environment of the same. As described in further detail below, the sensors 118 may be configured to operate as a measurement device and/or and actuator. In a measurement operation, certain characteristics may be measured relating to one or more fasteners, and the like. In an actuation operation, the sensors/actuators 118 may be caused to apply a force to a portion of an associated fastener 121 to cause the fastener 121 to actuate (e.g., open or close).

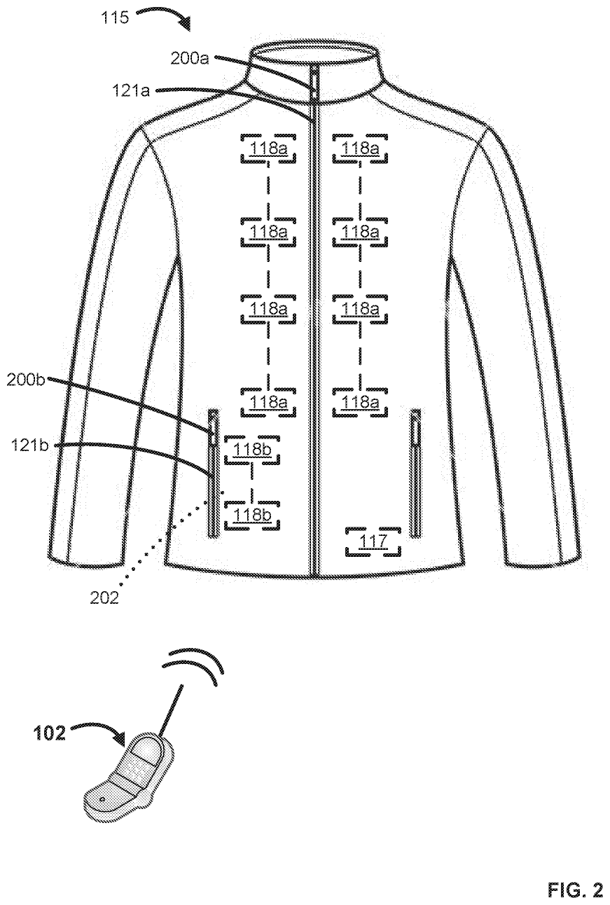

The sensors 118 may be or comprise inductive components configured to interact with respective fasteners 121. As an example, one or more of the fasteners 121 may be a zipper type fastener with a pull or slider that, when engaged, may be actuated to cause opposing rows of teeth to engage or disengage, thereby coupling or uncoupling two pieces of fabric. As another example, a pull (e.g., pull 200 (FIG. 2)) of a zipper type fastener may be magnetic and may be configured to interact with the inductive components of the sensors/actuators 118. In operation, as the magnetic pull is moved passed the sensors 118, the magnet may cause an electrical current to be generated in the sensors 118. In another operation, the sensors 118 may be energized.

The sensors 118 may be or comprise conductive components configured to interact with respective fasteners 121. The sensors 118 may be or comprise a conductive thread disposed (e.g., sewn, secured, woven, etc.) adjacent at least a portion of a respective fastener 121. As an example, one or more of the fasteners 121 may be a zipper type fastener with a pull or slider that, when engaged, may be actuated to cause opposing rows of teeth to engage or disengage, thereby coupling or uncoupling two pieces of fabric. As another example, a pull (e.g., pull 200 (FIG. 2)) of a zipper type fastener may be magnetic or energized and may be configured to interact with the conductive thread of the sensors/actuators 118. In operation, as the energized pull is moved passed the sensors 118, a resistance measurement through the sensors 118 may be measured.

As illustrated in FIG. 2, an example item of apparel 115 may include a plurality of sensors 118a, 118b. The sensors 118a, 118b may be in communication with each other or may be isolated from other sensors 118a, 118b. The sensors 118a, 118b may be in communication with each other via wireless or wired connection (e.g., conductive ink). The sensors 118a, 118b may be configured to send and receive information over various networks, specifications, and protocols. The sensors 118a, 118b may be disposed in any location of the item of apparel 115.

As an example, the sensors 118a may be disposed adjacent a fastener 121a extending in a chest panel region of the item of apparel 115. The fastener 121a may be a zipper type fastener and may include a pull 200a configured to engage teeth (not shown) disposed along an edge of the apparel 115. The pull 200a may be or comprise a magnetic element and, when moved passed the sensors 118a, may generate electrical current in the sensors 118a. The generated electrical current may be representative of a signal indicating a position of the pull 200a along the fastener 121a. For example, the generate current may be represented by a data burst transmitted to a device such as the user device 102. As a further example, the generated electrical current may be used to power a data burst transmission to a device such as the user device 102. Other power sources may be used. The data burst may include information such as an identifier of the particular sensor 118a that has been energized. As such, when the pull 200a is moved along the fastener 121a, the various sensors 118a may be energized and such responsive energizing may be communicated to a device such as the user device 102 for addition processing and/or transmission. Since a placement of the sensors 118a may be known, the signaling of the discrete sensors 118a, or a progression or power curve, may be representative of a movement rate and/or position of the pull 200a. Additionally or alternatively, when the pull 200a engages both of the opposing sets of teeth, a circuit may be closed and thereby indicate that the fastener 121a is engaged. Such information may be transmitted to a device such as the user device 102.

As another example, the sensors 118b may be disposed adjacent a fastener 121b extending to enclose a pocket 202 formed in the item of apparel 115. The fastener 121b may be a zipper type fastener and may include a pull 200b configured to engage teeth (not shown) disposed along an edge of the apparel 115. The pull 200b may be or comprise a magnetic element and, when moved passed the sensors 118b, may generate electrical current in the sensors 118b. The generated electrical current may be representative of a signal indicating a position of the pull 200b along the fastener 121b. For example, the generate current may be represented by a data burst transmitted to a device such as the user device 102. As a further example, the generated electrical current may be used to power a data burst transmission to a device such as the user device 102. Other power sources may be used. The data burst may include information such as an identifier of the particular sensor 118b that has been energized. As such, when the pull 200b is moved along the fastener 121b, the various sensors 118b may be energized and such responsive energizing may be communicated to a device such as the user device 102 for addition processing and/or transmission. Since a placement of the sensors 118b may be known, the signaling of the discrete sensors 118b, or a progression or power curve, may be representative of a movement rate and/or position of the pull 200b. Additionally or alternatively, when the pull 200b engages both of the opposing sets of teeth, a circuit may be closed and thereby indicate that the fastener 121b is engaged. Such information may be transmitted to a device such as the user device 102.

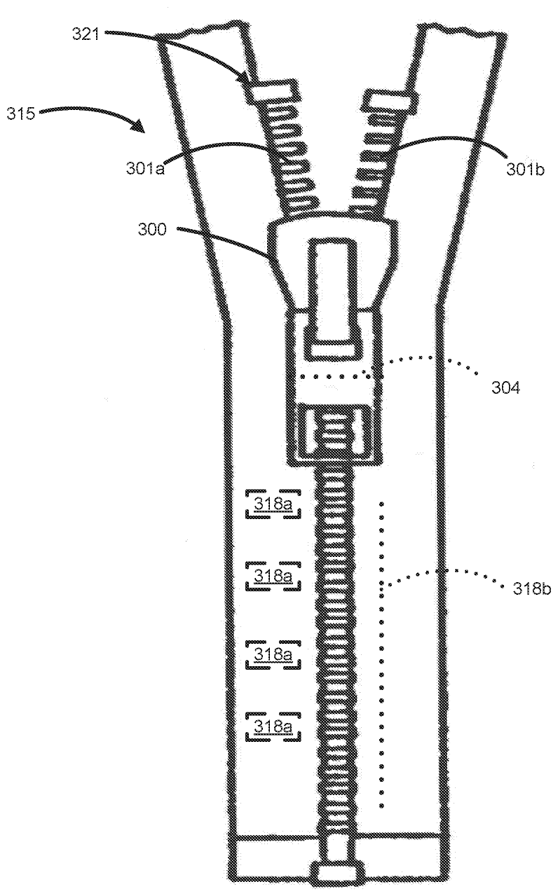

As illustrated in FIG. 3, an example item of apparel 315 may include a plurality of sensors 318a, 318b that may be similar to sensors/actuators 118 (FIG. 1). The sensors 318a, 318b may be in communication with each other or may be isolated from other sensors 318a, 318b. The sensors 318a, 318b may be in communication with each other via wireless or wired connection (e.g., conductive ink). The sensors 318a, 318b may be configured to send and receive information over various networks, specifications, and protocols. The sensors 318a, 318b may be disposed in any location of the item of apparel 315.

As an example, the sensors 318a may be disposed adjacent a fastener 321a associated with the item of apparel 315. The sensors 318a may be discrete and spaced apart. The sensors 318a may include inductive components such as a coil of conductive material. The fastener 321a may be a zipper type fastener and may include a pull 300 configured to engage opposing sets of teeth 301a, 301b disposed along respective edges of the apparel 315. The pull 300 may be or comprise a magnetic element and, when moved passed the sensors 318a, may generate electrical current in the sensors 318a. The generated electrical current may be representative of a signal indicating a position of the pull 300 along the fastener 321. For example, the generate current may be represented by a data burst transmitted to a device such as the user device 102 (FIG. 1). As a further example, the generated electrical current may be used to power a data burst transmission to a device such as the user device 102 (FIG. 1). Other power sources may be used.

The data burst may include information such as an identifier of the particular sensor 318a that has been energized. As such, when the pull 300 is moved along the fastener 321, the various sensors 318a may be energized and such responsive energizing may be communicated to a device such as the user device 102 (FIG. 1) for addition processing and/or transmission. Since a placement of the sensors 318a may be known, the signaling of the discrete sensors 318a, or a progression or power curve, may be representative of a movement rate and/or position of the pull 300. Additionally or alternatively, when the pull 300 engages both of the opposing sets of teeth 301a, 301b, a circuit may be closed via a conductive lead 304. The closed circuit may indicate that the fastener 321 is engaged. Such information may be transmitted to a device such as the user device 102 (FIG. 1).

As another example, the sensor 318b may be disposed adjacent the fastener 321. The sensor 318b may be or comprise a conductive thread. The conductive thread may have a linear configuration or other configuration. As such, the pull 300 may be moved along a length of the sensor 318b and may affect an electrical resistance measurement over the sensor 318b. The resistance may be representative of a signal indicating a position of the pull 300 along the fastener 321. For example, the resistance or change in resistance may be represented by a data burst transmitted to a device such as the user device 102 (FIG. 1). Since a placement and configuration of the sensor 318b may be known, the signaling of the sensor 318b may be mapped to a resistance curve or plot and may be representative of a movement rate and/or position of the pull 300. Various data points along the plot or curve may be used as thresholds to determine a characteristic of the pull 300 such as a position, movement, and/or speed of movement. For example, a table of electrical values (e.g., impedance, resistance, voltage, etc.) may be generated to represent various characteristic states of the pull 300. As such, subsequent measurements of electrical characteristics relative to the sensor 318 may be compared to the table of values to extrapolate a characteristic of the pull 300 from the table.

Returning to FIG. 1, one or more of the information sources 116 may include a datastore 119 for storing information such as information collected or received by the sensors 118. The information sources 116 may include information relating to environmental conditions such as temperature, wind, precipitation, and humidity. For example, the information sources 116 may be associated with a weather service that collects location-based information about temperature and/or humidity. Such information may be stored at the datastore 119 and/or may be made available for other systems to access or receive. The information sources 116 may perform analytics such as a statistical analysis, heuristics, and/or historical trends that may be used by systems access or receiving such information.

In an aspect, an apparel manager 120 may be configured to receive information from one or more of the user device 102, the computing device 104, the sensors 118, and the information source 116. The apparel manager 120 may be or include hardware and software configured to process received information and provide feedback relating to the received information. Various configurations of hardware and software components may be used. Other components having the same or similar functionality as the apparel manager 120 may be used. The apparel manager 120 may be accessed by one or more of the user devices 102 and the computing devices 104 and by be integrated as hardware or logic into various devices and/or processing elements. The apparel manager 120 may be a standalone component, distinct from the user device 102 and/or computing device 104 or may be integrated in one or more of the user device 102, the computing device 104, or other device or system. Although not every configuration of hardware and logical components is illustrated in the drawings, it is understood that the same is contemplated by the description presented herein.

In an aspect, the apparel manager 120 may include a pre-processor component 122 configured to receive data from various sources such as one or more computing nodes (e.g., computing device 104), the user device 102, the sensors 118, and/or the information source 116. As an example, the pre-processor component 122 may be configured to receive a data dump of information and/or may be configured to process the received or accessed data to filter at least a portion of the received or accessed data. As a further example, the pre-processor component 122 may be configured to filter/classify received information.

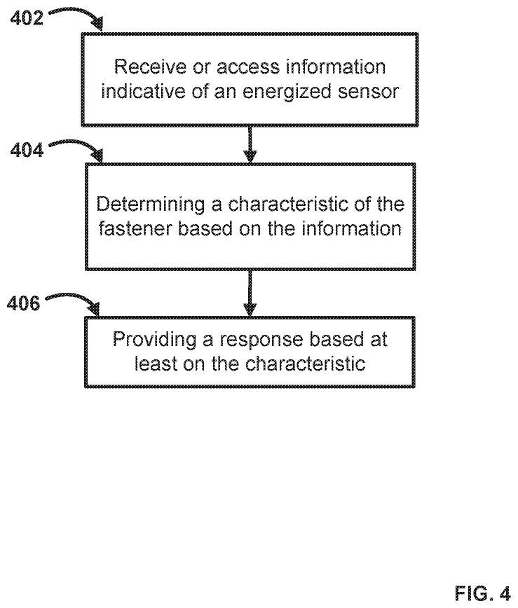

The apparel manager 120 may include an analytics component 124 configured to access or receive data (communication flows), for example, from the pre-processing component 122 or other data source. The analytics component 124 may be configured to analyze the received data, for example, using statistical analysis, comparative analysis, heuristics, and/or a machine learning algorithm to assess the current status and/or fastener profile relating to apparel and associated fasteners. As an example, the analytics component 124 may be configured to execute one or more operations such as described in FIG. 4. As a further example, the analytics component 124, or one or more other components of the apparel manager 120, may be configured to generate a fastener profile 130 for one or more fasteners 121 based on information received by the apparel manager 120. The fastener profiles 130 may be or comprise an alphanumeric index having values associated with various levels of comfort. The fastener profile 130 may be or comprise a profile having a plurality of parameters representing a state of the fastener 121. As an example, the fastener 121 may be a zipper type fastener and the fastener profile 130 may relate to a position and movement of a pull or slide of the fastener 121. Fastener profiles 130 may include patterns, power curves, signal plots, and other mechanisms for mapping a collected data from the sensors 118 to a position or movement of the fastener 121. Fastener profiles 130 may include information relating to the fastener 121 or associated apparel 115 such as a type of fastener, age of fastener, lifecycle of fastener, historical use, location of fastener, location of fastener on the apparel, fastener source, and the like. The fastener profiles 130 may be stored at a datastore 128 and/or other devices or storage such as the user device 102.

The apparel manager 120 may be configured to generate one or more fastener profiles 130 based on one or more fastener rules 132. The fastener rules 132 may include logic to control the analysis of information received by the apparel manager 120. As an example, the fastener rules 132 may include look-up tables (LUTs), IF-THEN relationships, key-value pairs, weighting algorithms, machine learning, heuristics, or other mechanism to aide in the generation of the fastener profiles 130. Such rules may be stored in any location such as the datastore 128.

A response component 126 may be configured to provide assessments and recommendations based on the analysis conducted by the analytics component 124. The assessments and recommendation may include a comfort summary, updates to the predictive comfort model, apparel recommendations, and updates to user or apparel profiles. For example, a wearer's fastener may be detected to be open and a weather report indicates rain is expected, therefor the response component 126 may send a recommendation to “zip up” the fastener to provide further protection from the rain. As another example, a fastener on a bag may be detected as being unfastened, exposing its contents, therefore the response component 126 may transmit a notification that the bag is open and should be closed. Received or accessed information, classifications, statistics, and/or remediation logs may be stored in the datastore 128. The response component 126 may be configured to autonomously update information relating to one or more items of apparel and associated users/wearers.

The response component 126 may be configured to provide a user interface element to a wearer, for example, via the user device 102 or other device. Such a user interface element may include audio feedback, visual feedback, tactile feedback, and the like. The user interface element may indicate an instruction to the user/wearer to manipulate the apparel to change comfort such as unzipping vents or zipping up a chest panel zipper. The user interface element may indicate a particular item of apparel to be worn and/or a particular fastener configuration. The user interface element may indicate a notice to the user/wearer relating to weather or other factor that may affect fastener placement. The user interface element may indicate a request for feedback from the user. Such a request may be representative of a feedback loop, whereby the user/wearer may agree or disagree with the fastener profile 130 applied to the wearer's or fastener's current state. Such user feedback can be used to influence weighting factors in the fastener rules 132 and/or other analytics leveraged by the apparel manager 120.

The fastener profiles 130 may be generated based at least on information relating to a particular user/wearer and/or a particular item of apparel 115. For example, a user profile or information relating to a particular user/wearer may be received or accessed by the apparel manager 120. The user profile may include information such as location, activity level, user schedule, and user preferences. Fastener profiles 130 may be generated based on one or more categories of information in the user profile. As an example, fastener profiles 130 may be generated based on various locations where the wearer is or will be located. As another example, fastener profiles 130 may be generated based on various activity levels of the wearer. As a further example, when a user is running, the fastener profile 130 may indicate that certain zipper-covered vents be opened to improve air flow and comfort of the user.

As an illustrative example, the apparel manager 120 may receive or access information from the sensors 118 (directly or indirectly). Such information may include measurements of characteristics such as a position or movement of fastener 121, sensor identifiers, sensor location (globally and/or locally on the apparel), sensor measurement time and/or location stamp, apparel identifier 117, user/wearer profile information, and the like.

For example, a particular wearer may be identified to the apparel manager 120, for example using a unique identifier, which may be a user generated credential or other identifier such as a unique IP address, MAC address of the user device 102, a system generated identifier, an apparel identifier 117 registered to a particular user/wearer, or the like. The unique identifier of the wearer may be used to differentiate information relating to one wearer from information relating to another wearer. The information received by the apparel manager 120 may be associated with one or more sources such as a wearer or information source 116. Identifiers may be used to distinguish the sources of information for processing of the information by the apparel manager 120.

The apparel manager 120 may be configured to monitor each of the sensors 118, individually and comparatively or collectively. Changes in measured characteristics may be tracked over time. Changes may be tracked and compared between sensors 118 associated with the same apparel 115 or sensors 118 associated with different apparel 115. Information from multiple sensors 118 may be aggregated and processed to provide statistical normalization, averages, standard deviation, and the like.

The fastener profile 130 may be generated based on one or more fastener rules 132. As an example, the fastener rules 132 may represent that a pre-defined delta between one or more calculated heat indices indicates a particular comfort level. As the delta between heat indices goes up or down, the applied comfort rule 132 may cause the fastener profile 130 to change. The fastener rules 132 may factor in location of the wearer, activity level, a user profile, apparel-specific information, and the like. Various weighting factors may be used to reflect the various parameters considered by the confront manager 120 in applying the fastener rules 132.

The application of fastener rules 132 and resultant fastener profiles 130 may be localized to a single item of apparel 115, or wearer, or region including one or more items of apparel 115 and wearers. The application of fastener rules 132 and resultant fastener profiles 130 may be “globalized” to represent a plurality of items of apparel 115 and wearers such as an aggregate over a larger region having one or more sub regions.

### Methods

FIG. 4 depicts example operating procedures that may be implemented by the systems and networks described hereon. For example, in reference to FIGS. 1-3, operation or step 402 may include receiving or accessing information. The information may be or include electrical characteristics of one or more sensors 118 such as electrical current or electric resistance. Additionally or alternatively, the first information may include a user identifier, apparel identifier 117, location, or time stamp, or combination thereof.

In operation or step 404, a characteristic of a fastener 121 may be determined based at least on the accessed or received information. The characteristic may comprises a position or movement of the fastener 121. As an example, the fastener 121 may be a zipper type fastener including a pull/slide. As such the characteristic may comprise a position or movement of the pull/slide of the fastener 121.

In operation or step 406, a response may be provided to a user or wearer based at least on the characteristic determined in step 404. The response may include assessments and recommendations based on the analysis relating to the apparel 115 and the fastener 121 of the apparel 115. The response may indicate or comprise a notification to the wearer of a fastener profile. The response may indicate or comprise instructions to the wearer, a suggestion to alter the item of apparel, or a suggested item of apparel, or a combination thereof

Those of skill will appreciate that the various illustrative logical blocks, modules, and algorithm steps described in connection with the aspects disclosed herein may be implemented as electronic hardware, computer software, or combinations of both. To clearly illustrate this interchangeability of hardware and software, various illustrative components, blocks, modules, and steps have been described above generally in terms of their functionality.

Whether such functionality is implemented as hardware or software depends upon the design constraints imposed on the overall system. Skilled persons may implement the described functionality in varying ways for each particular application, but such implementation decisions should not be interpreted as causing a departure from the scope of the invention. In addition, the grouping of functions within a module, block, or step is for ease of description. Specific functions or steps may be moved from one module or block without departing from the invention.

The various illustrative logical blocks and modules described in connection with the aspects disclosed herein may be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor (e.g., of a computer), or in a combination of the two. A software module may reside, for example, in RAM memory, flash memory, ROM memory, EPROM memory, EEPROM memory, registers, hard disk, a removable disk, a CD-ROM, or any other form of storage medium. An exemplary storage medium may be coupled to the processor such that the processor may read information from, and write information to, the storage medium. In the alternative, the storage medium may be integral to the processor. The processor and the storage medium may reside in an ASIC.

In at least some aspects, a processing system (e.g., electronic control system or devices 104, 120) that implements a portion or all of one or more of the technologies described herein may include a general-purpose computer system that includes or is configured to access one or more computer-accessible media.

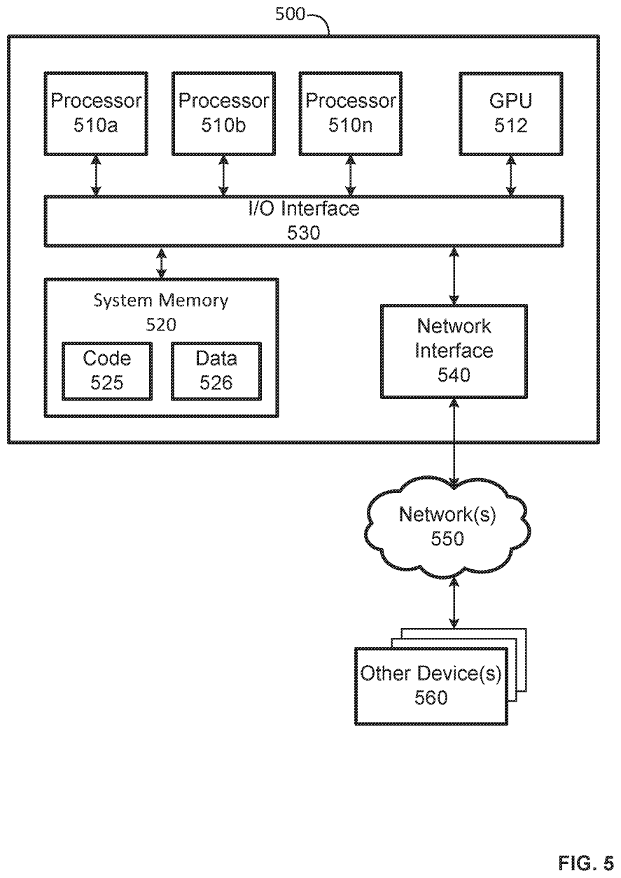

FIG. 5 depicts a general-purpose computer system that includes or is configured to access one or more computer-accessible media. In the illustrated aspect, computing device 500 includes one or more processors 510a, 510b, and/or 510n (which may be referred herein singularly as a processor 510 or in the plural as the processors 510) coupled to a system memory 520 via an input/output (I/O) interface 530. Computing device 500 further includes a network interface 540 coupled to I/O interface 530.

In various aspects, computing device 500 may be a uniprocessor system including one processor 510 or a multiprocessor system including several processors 510 (e.g., two, four, eight, or another suitable number). Processors 510 may be any suitable processors capable of executing instructions. For example, in various aspects, processor(s) 510 may be general-purpose or embedded processors implementing any of a variety of instruction set architectures (ISAs), such as the x86, PowerPC, SPARC, or MIPS ISAs, or any other suitable ISA. In multiprocessor systems, each of processors 510 may commonly, but not necessarily, implement the same ISA.

In some aspects, a graphics processing unit (“GPU”) 512 may participate in providing graphics rendering and/or physics processing capabilities. A GPU may, for example, include a highly parallelized processor architecture specialized for graphical computations. In some aspects, processors 510 and GPU 512 may be implemented as one or more of the same type of device.

System memory 520 may be configured to store instructions and data accessible by processor(s) 510. In various aspects, system memory 520 may be implemented using any suitable memory technology, such as static random access memory (“SRAM”), synchronous dynamic RAM (“SDRAM”), nonvolatile/Flash®-type memory, or any other type of memory. In the illustrated aspect, program instructions and data implementing one or more desired functions, such as those methods, techniques and data described above, are shown stored within system memory 520 as code 525 and data 526.

In one aspect, I/O interface 530 may be configured to coordinate I/O traffic between processor(s) 510, system memory 520 and any peripherals in the device, including network interface 540 or other peripheral interfaces. In some aspects, I/O interface 530 may perform any necessary protocol, timing or other data transformations to convert data signals from one component (e.g., system memory 520) into a format suitable for use by another component (e.g., processor 510). In some aspects, I/O interface 530 may include support for devices attached through various types of peripheral buses, such as a variant of the Peripheral Component Interconnect (PCI) bus standard or the Universal Serial Bus (USB) standard, for example. In some aspects, the function of I/O interface 530 may be split into two or more separate components, such as a north bridge and a south bridge, for example. Also, in some aspects some or all of the functionality of I/O interface 530, such as an interface to system memory 520, may be incorporated directly into processor 510.

Network interface 540 may be configured to allow data to be exchanged between computing device 500 and other device or devices 560 attached to a network or networks 550, such as other computer systems or devices, for example. In various aspects, network interface 540 may support communication via any suitable wired or wireless general data networks, such as types of Ethernet networks, for example. Additionally, network interface 540 may support communication via telecommunications/telephony networks, such as analog voice networks or digital fiber communications networks, via storage area networks, such as Fibre Channel SANs (storage area networks), or via any other suitable type of network and/or protocol.

In some aspects, system memory 520 may be one aspect of a computer-accessible medium configured to store program instructions and data as described above for implementing aspects of the corresponding methods and apparatus. However, in other aspects, program instructions and/or data may be received, sent, or stored upon different types of computer-accessible media. Generally speaking, a computer-accessible medium may include non-transitory storage media or memory media, such as magnetic or optical media, e.g., disk or DVD/CD coupled to computing device 500 via I/O interface 530. A non-transitory computer-accessible storage medium may also include any volatile or non-volatile media, such as RAM (e.g., SDRAM, DDR SDRAM, RDRAM, SRAM, etc.), ROM, etc., that may be included in some aspects of computing device 500 as system memory 520 or another type of memory. Further, a computer-accessible medium may include transmission media or signals, such as electrical, electromagnetic or digital signals, conveyed via a communication medium, such as a network and/or a wireless link, such as those that may be implemented via network interface 540. Portions or all of multiple computing devices, such as those illustrated in FIG. 5, may be used to implement the described functionality in various aspects; for example, software components running on a variety of different devices and servers may collaborate to provide the functionality. In some aspects, portions of the described functionality may be implemented using storage devices, network devices or special-purpose computer systems, in addition to or instead of being implemented using general-purpose computer systems. The term “computing device,” as used herein, refers to at least all these types of devices and is not limited to these types of devices.

It should also be appreciated that the systems in the figures are merely illustrative and that other implementations might be used. Additionally, it should be appreciated that the functionality disclosed herein might be implemented in software, hardware, or a combination of software and hardware. Other implementations should be apparent to those skilled in the art. It should also be appreciated that a server, gateway, or other computing node may include any combination of hardware or software that may interact and perform the described types of functionality, including without limitation desktop or other computers, datastore servers, network storage devices and other network devices, PDAs, tablets, cellphones, wireless phones, pagers, electronic organizers, Internet appliances, television-based systems (e.g., using set top boxes and/or personal/digital video recorders), and various other consumer products that include appropriate communication capabilities. In addition, the functionality provided by the illustrated modules may in some aspects be combined in fewer modules or distributed in additional modules. Similarly, in some aspects the functionality of some of the illustrated modules may not be provided and/or other additional functionality may be available.

Each of the operations, processes, methods, and algorithms described in the preceding sections may be embodied in, and fully or partially automated by, code modules executed by at least one computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto may be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example aspects. The example systems and components described herein may be configured differently than described. For example, elements may be added to, removed from, or rearranged compared to the disclosed example aspects.

It will also be appreciated that various items are illustrated as being stored in memory or on storage while being used, and that these items or portions of thereof may be transferred between memory and other storage devices for purposes of memory management and data integrity. Alternatively, in other aspects some or all of the software modules and/or systems may execute in memory on another device and communicate with the illustrated computing systems via inter-computer communication. Furthermore, in some aspects, some or all of the systems and/or modules may be implemented or provided in other ways, such as at least partially in firmware and/or hardware, including, but not limited to, at least one application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network, or a portable media article to be read by an appropriate drive or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other aspects. Accordingly, the present invention may be practiced with other computer system configurations.

Conditional language used herein, such as, among others, “may,” “could,” “might,” “may,” “e.g.,” and the like, unless specifically stated otherwise, or otherwise understood within the context as used, is generally intended to convey that certain aspects include, while other aspects do not include, certain features, elements, and/or steps. Thus, such conditional language is not generally intended to imply that features, elements, and/or steps are in any way required for at least one aspects or that at least one aspects necessarily include logic for deciding, with or without author input or prompting, whether these features, elements, and/or steps are included or are to be performed in any particular aspect. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example aspects have been described, these aspects have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

The preceding detailed description is merely exemplary in nature and is not intended to limit the invention or the application and uses of the invention. The described aspects are not limited to use in conjunction with a particular type of apparel. Furthermore, there is no intention to be bound by any theory presented in the preceding background or detailed description. It is also understood that the illustrations may include exaggerated dimensions to better illustrate the referenced items shown, and are not consider limiting unless expressly stated as such.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context.

1. A method for managing a fastener association with an item of apparel, the method comprising:
receiving information indicative of an energized sensor, wherein the energized sensor is disposed adjacent a fastener that is associated with an item of apparel;
determining a characteristic of the fastener based at least upon the received information, wherein determining the characteristic comprises determining a curve indicative of one or more of a movement rate or position of at least a portion of the fastener; and
providing a response to a wearer of the item of apparel based at least upon the characteristic of the fastener.

2. The method of claim 1, wherein the received information comprises an identifier associated with the sensor.

3. The method of claim 1, wherein the sensor comprises an inductor.

4. The method of claim 1, wherein the sensor comprises a conductive thread.

5. The method of claim 1, wherein determining the characteristic of the fastener determining a power curve indicative of one or more of a movement rate or position of at least a portion of the fastener.

6. The method of claim 1, wherein the characteristic comprises a position or movement of the fastener.

7. The method of claim 1, wherein the fastener comprises a zipper type fastener including a pull, and wherein the characteristic comprises a position or movement of the pull.

8. The method of claim 1, wherein the response to the wearer indicates a notification to the wearer of a fastener profile, instructions to the wearer, a suggestion to alter the item of apparel, or a suggested item of apparel, or a combination thereof.

9. The method of claim 1, wherein the response comprises a notification of the characteristic of the fastener.

10. A fastener system comprising:
a moveable fastener configured to cause two opposing portions of an item of apparel to be selective coupled and uncoupled based on movement of the fastener;
a plurality of sensors disposed adjacent a portion of the fastener, wherein a movement of the fastener relative to the plurality of sensors causes an electrical current to be generated in the plurality of sensors, wherein each of the plurality of sensors is discrete and spaced apart from the other sensors; and
causing transmission of information relating to the generated electrical current.

11. The fastener system of claim 10, wherein the sensor comprises an inductor.

12. The fastener system of claim 10, wherein the sensor comprises a conductive thread.

13. The fastener system of claim 10, wherein the transmitted information comprises a characteristic of the fastener.

14. The fastener system of claim 13, wherein the characteristic comprises a position or movement of the fastener.

15. The fastener system of claim 10, wherein the fastener comprises a zipper type fastener including a pull.

16. The fastener system of claim 10, wherein the generated electrical current is used to power at least a portion of the transmission of information.

17. A fastener system comprising:
a moveable fastener configured to cause two opposing portions of an item of apparel to be selective coupled and uncoupled based on movement of the fastener;
an electrical actuator disposed adjacent a portion of the fastener, wherein an energizing of the actuator causes movement or limits movement of the fastener relative to the actuator; and
receiving an electrical signal at the actuator to energize the actuator.

18. The fastener system of claim 17, wherein the actuator comprises an inductor.

19. The fastener system of claim 17, wherein the actuator comprises a conductive thread

20. The fastener system of claim 17, wherein the fastener comprises a zipper type fastener including a pull.
